(19) United States
(12) Patent Application Publication
(10) Pub. No.: US 2013/0292960 A1
(43) Pub. Date: Nov. 7, 2013

(54) ANTI-THEFT DEVICE FITTED TO THE SEAT OF THE VEHICLE

(71) Applicants: Volodymyr Shyshkin, Yalta (UA); Kateryna Shahnewaz, Reston, VA (US)

(72) Inventors: Volodymyr Shyshkin, Yalta (UA); Kateryna Shahnewaz, Reston, VA (US)

(21) Appl. No.: 13/463,048

(22) Filed: May 3, 2012

(51) Int. Cl. B60R 25/00; B60N 2/32

(52) U.S. Cl. 296/65.16

(57) ABSTRACT

An anti-theft device fitted to the seat of the vehicle is provided for a motor vehicle. The seat containing a cushion, a frame and a back, including a mechanism for adjusting the angle of inclination of the seat back and comprising a fixed part and movable part. The fixed part and movable part located in the seat back and interact with each another with an additional horizontal axis and a lever. The movable part is adapted to forward rotation on the additional axis simultaneously with a gear-wheel, which holds the lever that locks the tilt-adjustment seat by the opposite end and driven by a pinion. The additional axle has the ability to horizontal displacement in the holding of its joints, forming an actuator of the locking device. The invention can be used to improve the seats ergonomics and for the bulk of transformations in the car.

### TECHNICAL FIELD AND INDUSTRIAL APPLICABILITY OF THE INVENTION

This invention relates to the transport vehicles, in particular for the production and use of car seats.

### BACKGROUND OF THE INVENTION

Anti-theft devices for cars are known. Also known are anti-theft devices which lock a vehicle seat in different forward positions preventing unauthorized use of a driver's side seat and/or manipulation of a steering wheel. Most of these devices have a complicated structure and does not take into account the characteristics of the inverse transformation of seat back.

U.S. Pat No. 6,048,019 to Tauber for a Car Security System and 6,746,071 to Farino for a Vehicle Theft Prevention Device each require movement of seats together with the transformation of the seats back, which complicates the structure and conditions of its operation.

U.S. Pat No. 5,415,458 to Kim for a Driver Seat Lock Mechanism for Preventing Vehicle Theft, U.S. Pat No. 5,412,964 to Shoony for a Anti-theft Device for a Motor Vehicle, U.S. Pat No. 5,628,215 to Brown for a Front Seat Locking Device each non take into account the characteristics of the inverse transformation of seat back.

These deficiencies affect the limited range of vehicles, in which can be used these devices. As a review of the prior art reveals, a need for an effective anti-theft device in the seat of the vehicle, wherein both high ergonomics and simplicity of the structure.

### SUMMARY OF THE INVENTION

It is, therefore, an object of the present invention to provide a reliable blocking of drive in a vehicle seat through the spatial transformation of the structural elements of the seat arranged in a vertical plane, simplifying seat structure and expansion of the range of vehicles to use this seat. This technical result is achieved by following a set of elements. The seat of the vehicle contains the cushion, the frame and the back, includes the mechanism for adjusting the angle of inclination of the seat back and anti-theft system. The fixed part and movable part located in the seat back and interact with each another with the additional horizontal axis and the lever. The movable part is adapted to forward rotation on the additional axis simultaneously with the gear-wheel, which holds the lever that locks the tilt-adjustment seat by the opposite end and driven by the pinion. The additional axle has the ability to horizontal displacement in the holding of its joints, forming an actuator of the locking device, which is entering into the hole of the special form, for example, a square, of the rigid element, which is mounted on the fixed part of the seat back and holding mentioned joints.

The location of fixed and movable parts in the seat back liberates a cushion frame for the implementation of mechanisms for adjusting the seat, placing devices depreciation of seat, control systems of the driver, seat heating, etc. The presence in the functional volume of the seat cushion an additional (anti-theft) system makes it difficult to implement these functions in the seat structure, raises the cost of production.

Additional axis with the ability to horizontal displacement articulated the fixed and movable parts of the seat back, creating the possibility of rotation of the movable part forward in the direction of the steering, while previously exposed seat-back angle remains the fixed part. This is the main effect of blocking anti-theft system of the present invention. At the same time blocked access to the pedals driving. At the same time, the additional horizontal axis forms an actuator of the locking device that moves the secondary axis, for example, to the left to fix the slope of the movable part of the seat. The gear-wheel is located on the additional axis and keeps the lever, forms reducer with the pinion, which makes it possible to automate the whole sequence of anti-theft device. At the same time the lever locks the mechanism for adjusting the angle of inclination of the seat back, so it becomes impossible to mechanically bypass the anti-theft function of the seat. This solution significantly reduces the number of parts involved in the anti-theft system, allows for cost-effectively equip such a system seats of various vehicle models.

### BRIEF DESCRIPTION OF THE DRAWINGS

FIG. 1 shows a vehicle seat in operating position, side view.

FIG. 2 shows the seat in position, view in the course of driving.

FIG. 3 shows the position of the seat to the activation of anti-theft system, side view.

FIG. 4 shows the position of the seat to the activation of anti-theft system, view in the course of driving.

FIG. 5 shows the kinematic scheme of the mechanism of anti-theft function, and its location relative to elements of the seat.

### DETAILED DESCRIPTION OF THE INVENTION

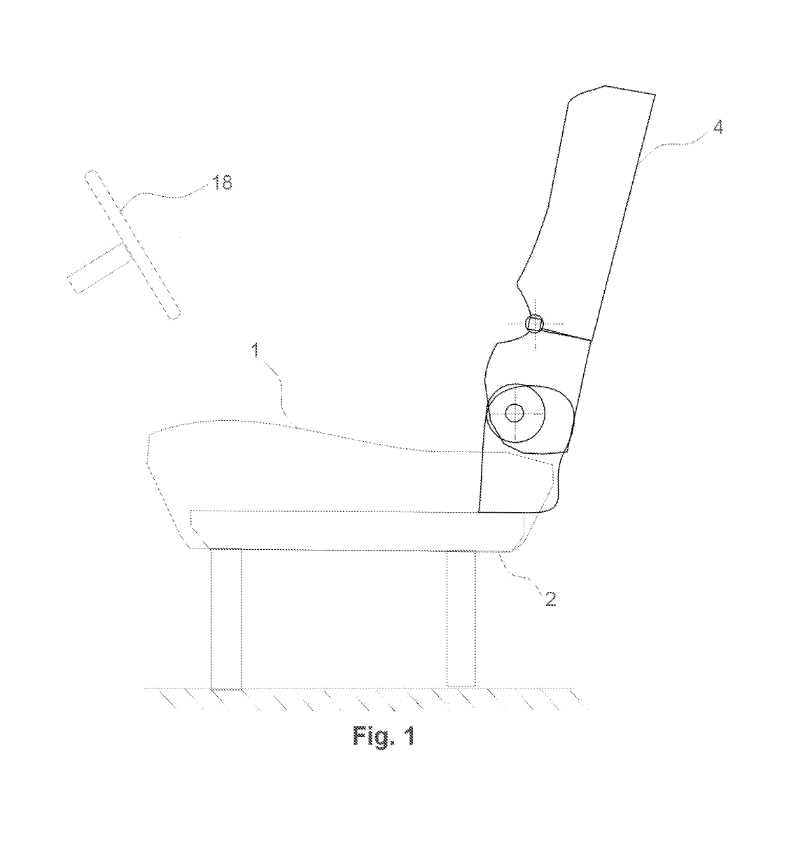

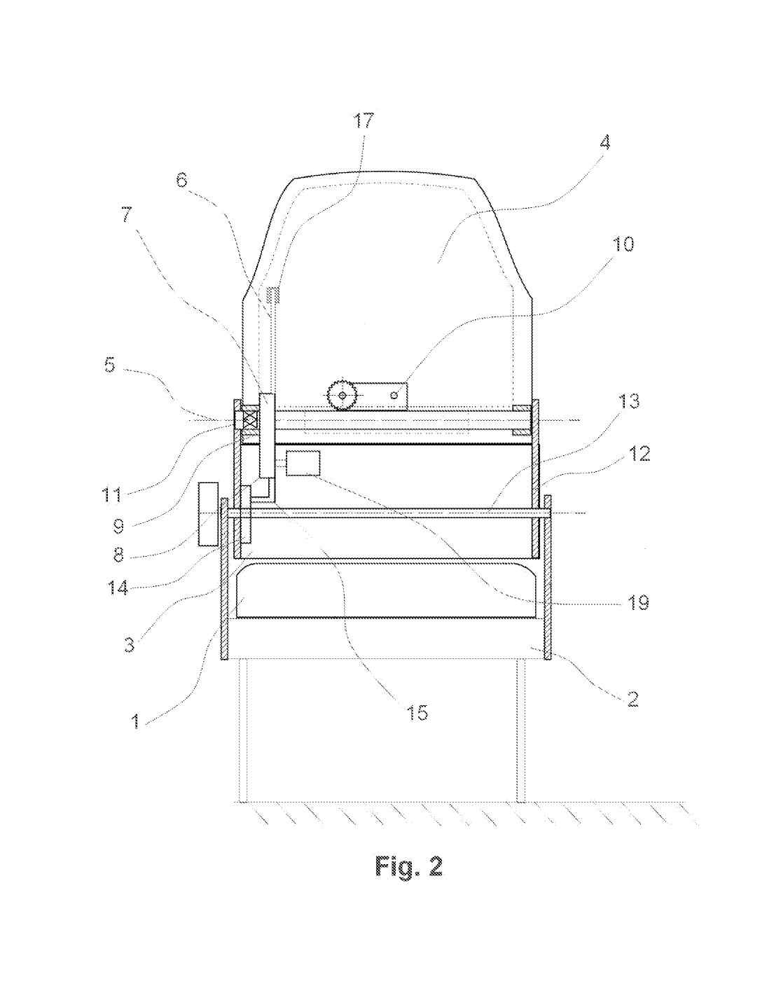

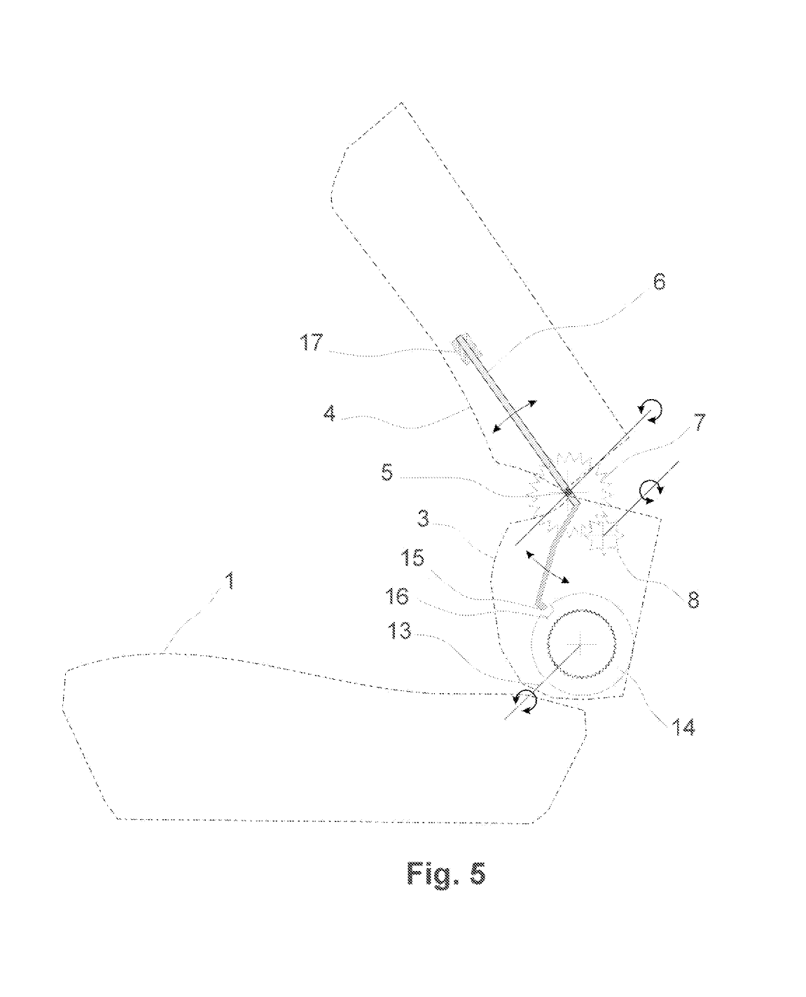

The anti-theft device fitted to the seat of the vehicle (FIG. 1, FIG. 2) contains the cushion 1, mounted on the frame 2 and the seat back includes the possibility of adjusting the angle of inclination (the mechanism is shown a partially) and comprises the fixed part 3 and movable part 4, which interact together with the additional axis 5 and the lever 6. The movable part 4 is adapted to forward rotation. The additional axis 5 simultaneously is the axis of the gear-wheel 7, which driven by the pinion 8 and has the ability to move in a horizontal restraint of its joints 9, forming an actuator of the locking device 10, which is entering into the hole 11 of the rigid element 12, mounted on the fixed part 3 of the seat back and holding the joints 9. Adjusting the angle of the seat back is carried out with rotation around the axis 13 through the mechanism 14. The lever 6 has the stud 15 at the opposite end from the movable part 4. The stud 15 is at an inclination of the movable part 4 of forward enters into the recess 16 (FIG. 5) on the adjustment mechanism 14 and blocks it. Sleeve 17 provides a interaction of the movable part frame 4 with the lever 6. The gear-wheel 7 and pinion 8 merged into reducer, connected to the engine 19 (FIG. 2).

The seat of the vehicle containing the anti-theft system works this way. In the working position (FIG. 1, FIG. 2), after setting by mechanism 14 (shown partially) the required angle of inclination of the seat back, the stud 15 of the lever 6 removed from the recess 16 (FIG. 5), the locking device 10 is activated and the additional axis shifted to the left in the joints, such that its end enters a hole 11 of rigid element 12. The movable part 4 of the seat back is fixed with respect to the fixed part 3. The rotation about the axis 5 of the movable part 4 is blocked by the special shape of the hole 11 of the rigid element 12, for example, a square, which corresponds to the intersection of the axis 5. The rotation about the axis 5 of the movable part 4 is also blocked by self-braking reducer consisting of the gear-wheel 7 and pinion 8.

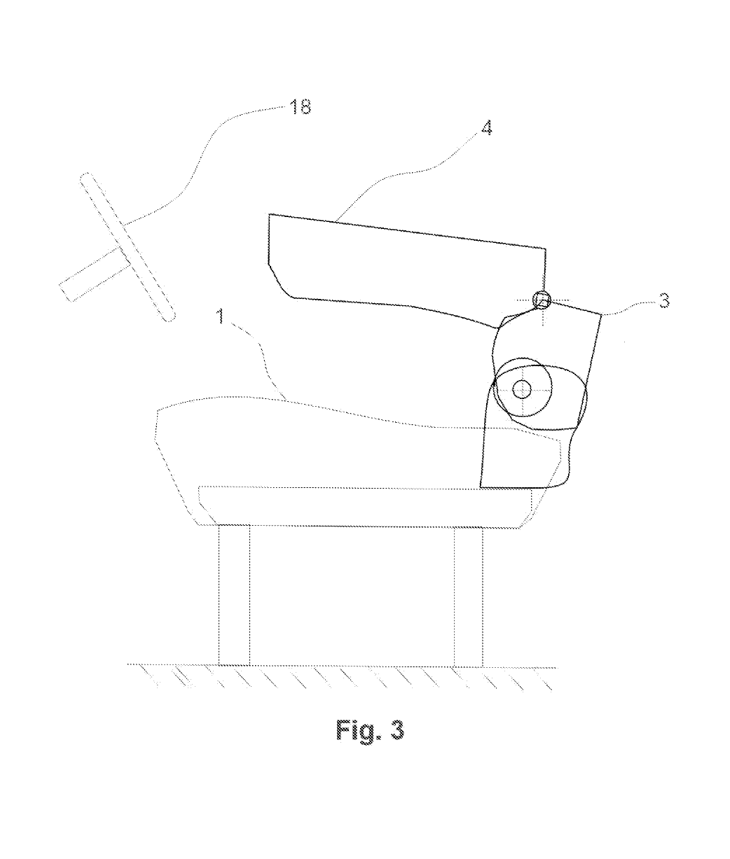

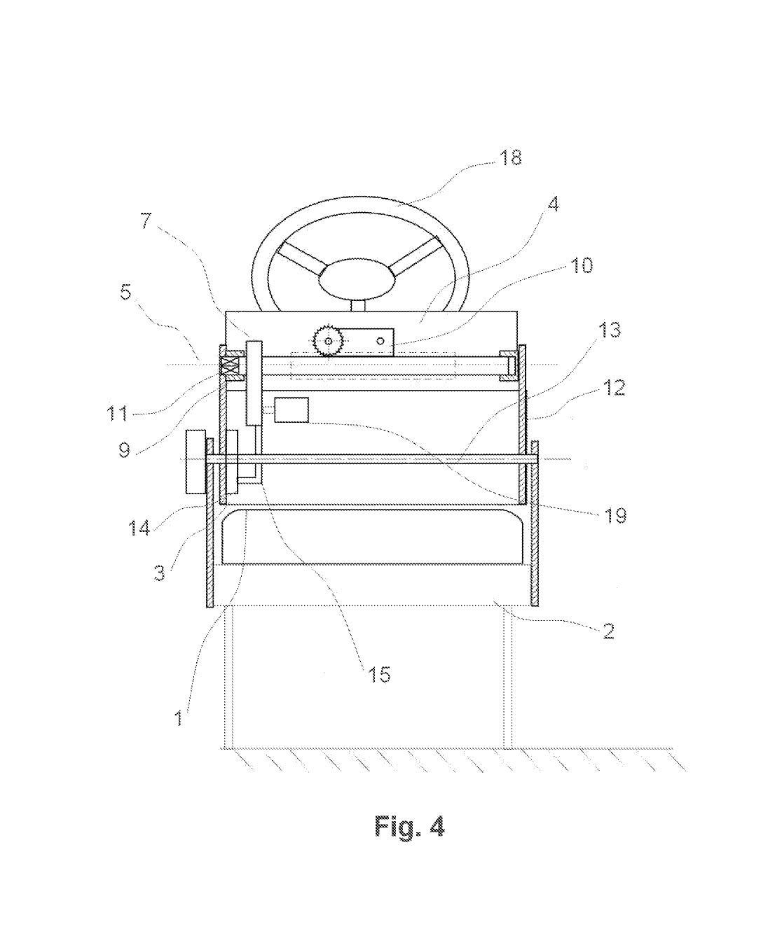

To use anti-theft system vehicle seat the locking device 10 is deactivated, the additional axis 5 derived from the hole 11 and the rigid element 12, the movable part 4 of the seat back is rotated around the additional axis 5 to 90 degrees forward (to the intersection of a pair of hole 11—axis 5 in the form of a square). To do this using the electric motor 19, set in motion the pinion 8 that moves the gear-wheel 7. The gear-wheel 7 through lever 6 acts on the movable part 4, and rotates it around the axis 5. In the final position of the lever 6 its stud 15 enters into the recess 16 (FIG. 5) on the adjustment mechanism 14 and block it, which does not allow mechanical bypass anti-theft function of the seat. After that the locking device 10 is activated and the axis 5 returns to its original condition. Activation of the locking device 10 can be operated manually or by an additional engine remotely. The movable part 4 of the seat back prevents access to the steering wheel 18 and to other drive organs (FIG. 3, FIG. 4). In reverse order leads to the return of the seat back in working position.

The device can be also used to improve the ergonomics of seats and for the bulk transformations in the car, for example, when equipment similar device of other seats.

By changing the shape of the section a pair of hole 11—axis 5 (triangle, hexagon) can change the pitch angle of the movable part 4 of the seat back with respect to the fixed part 3 (120 degrees, 60 degrees—respectively).

What is claimed is:

1. An anti-theft device fitted to the seat of the vehicle containing the cushion, the frame and the seat back, including a mechanism for adjusting the angle of inclination of the seat back and comprising the fixed part and movable part, which is characterized in that the fixed part and movable part located in the seat back and interact with each another with the additional horizontal axis and the lever, while the movable part is adapted to forward rotation on the additional axis simultaneously with the gear-wheel, which holds the lever that locks the tilt-adjustment seat by the opposite end and driven by the pinion, and the additional axle has the ability to horizontal displacement in the holding of its joints, forming an actuator of the locking device, which is entering into the special form hole, for example, a square, of the rigid element, which is mounted on the fixed part of the seat back and holding mentioned joints.
